(19) United States
(12) Patent Application Publication
(10) Pub. No.: US 2006/0255219 A1
(43) Pub. Date: Nov. 16, 2006

(54) [HAIR DRIER SUPPORT RACK]

(75) Inventor: Ming-Jeing Wang, TAIPEI (TW)

Correspondence Address: MING-JEING WANG, P.O. BOX 108-00403, TAIPEI, TW

(73) Assignee: Mr. Ming-Jeing Wang, Ping-Chun City (TW)

(21) Appl. No.: 10/908,274

(22) Filed: May 5, 2005

(51) Int. Cl. F16M 11/00; A47F 5/00

(52) U.S. Cl. 248/176.1; 248/309.1

(57) ABSTRACT

A support rack, for holding a hair drier is disclosed. The support rack comprises a base. The base comprises a support side and a groove, wherein said base comprises a support set extending from a top surface thereof. The support set comprises a support portion on a surface thereof to support an air outlet of said hair drier, and wherein a handle of said hair drier is supported in said groove and said air outlet is supported against said support portion for positioning.

### BACKGROUND OF THE INVENTION

1. The Field of the Invention

The present invention relates a support rack, and more particularly, to a support rack for securely holding and positioning a hair drier so that no additional space is required for storage thereof.

2. Description of Related Art

The hair drier is an essential household electrical device for every family, and usually users place the hair drier at a convenient location where additional storage space is required that cause inconvenience to the users.

To overcome the abovementioned problems, some of the manufacturers designed a ring for hanging the hair drier on the wall. However, the appearance of a hanging the hair drier on the wall is not pleasant. The ring is designed to fix to a distal end of the hair drier, and ring is then hung on the wall. If the hair drier is hit by an accidental external force, the hair drier may strike against the wall or the ring may come loose and thereby damage the hair drier.

Therefore, how to overcome the abovementioned defects is very important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a new support rack.

According to an aspect of the present invention, a support rack comprising a groove for positioning the handle of the hair drier therein so that the primal portion and the air outlet of the hair drier could be securely supported against the support side and the support portion for securely holding the hair drier on the support rack and also for minimizing the space occupied by the hair drier.

### BRIEF DESCRIPTION OF THE DRAWING

For a more complete understanding of the present invention, reference will now be made to the following detailed description of preferred embodiments taken in conjunction with the following accompanying drawings.

FIG. 1 is an elevational view a hair drier support rack according to an embodiment of the present invention.

FIG. 2 is a perspective view of the hair drier support rack according to a preferred embodiment of the present invention.

FIG. 3 is a perspective view of the hair drier support rack according to another preferred embodiment of the present invention.

### DETAILED DESCRIPTION OF PREFERRED EMBODIMENTS

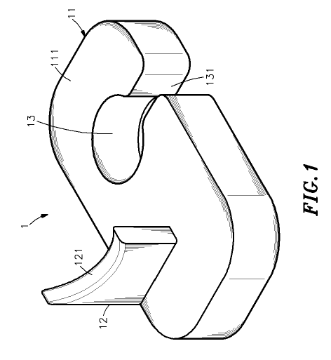

FIG. 1 shows an elevational view of a hair drier support rack according to an embodiment of the present invention. The hair drier support rack comprises a support rack 1 having a base 11, wherein the base 11 comprises a support side 111 and a groove 13 on a surface thereof. The groove 13 comprises a neck portion 131 at a flange thereof. The base 11 comprises a support set 12 protruding from a flat surface thereof, wherein the support set 12 comprises a bent support portion 121.

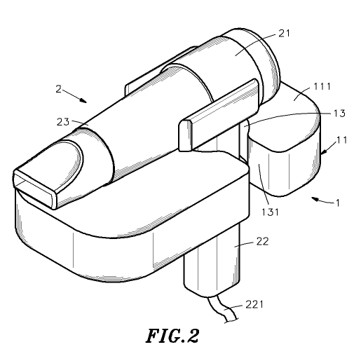

FIG. 2 shows a perspective view of the hair drier support rack according to a preferred embodiment of the present invention. Referring to FIG. 2, an electrical wire 221 and a handle 22 of a hair drier 2 is pushed into the groove 13 of the base 11 via the neck portion 131 and then the handle 22 is radially pushed into the groove 13 until an air outlet 23 of the hair drier 2 and a primal portion 21 far away from the air outlet 23 come in contact with the support side 111 of the base 11 to securely position the hair drier 2 on the support rack 1. Thus, not only the storage space occupation is reduced but also the hair drier 2 is securely positioned to substantially reduce the possibility of damage due to accidental external force.

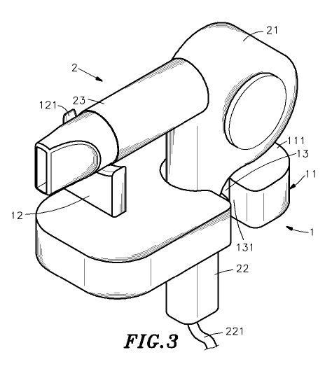

As described above, the hair drier 2 is flatly attached to the surface of the base 11. FIG. 3 shows a hair drier support rack according to another preferred embodiment of the present invention. Referring to FIG. 3, for securely positioning the hair drier 2 on the rack 1, the support side 111 comprises a support set 12 protruding from a surface thereof, wherein the support set 12 comprises a support portion 121 formed on a surface thereof. The support portion 121 may comprise an indentation. For securing the hair drier 2 on the rack 1, first, the electrical wire 221 extending through the handle 22 is passed through the groove 13 via the neck portion 131, and then the handle 22 of the hair drier 2 is pushed into the groove 13. Thus, the handle 22 firmly is supported against the neck portion 131 and a portion of which protrude out of the through groove 13. The air outlet 23 and the primal portion 21 of the hair drier 2 are supported against the two sides of the support portion 121 and the support side 111 respectively. The securely effect provided by this embodiment is similar to the previous embodiment described above.

As described above, the support rack 1 of the present invention has the advantages over the conventional hair dried holder. Because support rack 1 of the present invention comprises the base 11 having a support side 111 and the support set 12, wherein the support set 12 comprises a support portion 121, the primal portion 21 and the air outlet 23 of the hair drier 2 can be respectively supported against the support side 111 and the support portion 121. Thus, hanging the hair drier 2 on the wall can be effectively avoided. The hair drier 2 can be effectively supported by the support set 12 and secured on the support rack 1 and the space occupation can be reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A support rack, for holding a hair drier, comprising a base, comprising a support side and a groove, wherein said base comprises a support set extending from a top surface thereof, said side support set comprises a support portion on a surface thereof to support an air outlet of said hair drier, and wherein a handle of said hair drier is supported in said groove and said air outlet is supported against said support portion for positioning.

2. The support rack for holding a hair drier according to claim 1, wherein said support set and base are integrally formed.

3. The support rack for holding a hair drier according to claim 1, wherein said support portion comprises an indentation.

4. The support rack for holding a hair drier according to claim 1, wherein said groove comprises a neck portion formed at a flange thereof.
